(19) United States
(12) Patent Application Publication
(10) Pub. No.: US 2026/0012362 A1
(43) Pub. Date: Jan. 8, 2026

(54) RING SIGNATURE SYSTEM, TERMNAL, METHOD, AND PROGRAM

(71) Applicant: NTT, Inc., Tokyo (JP)

(72) Inventors: Kazuki YAMAMURA, Tokyo (JP); Tetsuya OKUDA, Tokyo (JP)

(21) Appl. No.: 18/873,476

(22) PCT Filed: Jun. 17, 2022
(86) PCT No.: PCT/JP2022/024423

§ 371 Date: Dec. 10, 2024

(51) Int. Cl. H04L 9/32; H04L 9/30

(52) U.S. Cl. CPC H04L 9/3252; H04L 9/3093

(57) ABSTRACT

According to an aspect of the present disclosure, a ring signature system includes: a plurality of member terminals belonging to a ring signature group; and a verifier terminal that verifies a ring signature. Each of the member terminals includes a key generation unit configured to generate a public key and a secret key of lattice-based cryptography as a verification key and a signature key, respectively, and a signature generation unit configured to generate a signature for a message by a linkable ring signature to which a Schnorr signature is applied using the signature key of the member terminal and verification keys of the other member terminals. The verifier terminal includes a verification unit configured to verify the signature using a verification key of the member terminal and the message.

### TECHNICAL FIELD

The present disclosure relates to a ring signature system, a terminal, a method, and a program.

### BACKGROUND ART

The number of electronic signature transactions is increasing mainly in blockchains and the like. A general electronic signature (hereinafter also simply referred to as a “signature”) has a one-to-one correspondence with a public key (verification key) for verifying the signature. Therefore, a signer can be identified by tracing the public key of the signer from the signature given to each transaction. That is, a general electronic signature is traceable.

Meanwhile, there are an increasing number of use cases in which the privacy of a signer needs to be protected. In a blockchain, an AOS ring signature in which an actual signer cannot be identified from the number of ring members N, and a traceable ring signature in which a public member can identify a signer only in the case of a double signature, and the like have been put into practical use.

In a configuration proof (remote attestation) of a device such as Intel (registered trademark) SGX or a trusted platform module (TPM), a group signature called an enhanced privacy ID (EPID) or direct anonymous attestation (DAA) has been put into practical use. With such a group signature, not only can a public member not identify an actual signer from the number of group members N but also a group administrator cannot identify a signer, and privacy protection/anonymization of the signer is enhanced while operation management by the group administrator is maintained.

An existing ring signature is a signature in which there is no group administrator as in a group signature and a privacy requirement of anonymity/unlinkability/untraceability is satisfied. Meanwhile, with recent reinforcement of Anti Money Laundering/Countering the Financing of Terrorism (AML/CFT) related regulations mainly in Europe, a need to enable identification/tracking of a fraudulent signer or signature-to-signature combination has increased. In recent years, in the field of an electronic signature technology, quantum computer resistant cryptography has been increasingly adopted in preparation for a threat posed by quantum computers. As an electronic signature technology in consideration of the above circumstances, a linkable ring signature (LRS) based on the quantum computer resistant cryptography is known (Non Patent Literatures 1 and 2).

### CITATION LIST

### Non Patent Literature

Non Patent Literature 1: Lu, X., Au, M. H., Zhang, Z. (2019). Raptor: A Practical Lattice-Based (Linkable) Ring Signature. In: Deng, R., Gauthier-Umana, V., Ochoa, M., Yung, M. Applied Cryptography and Network Security. ACNS 2019. Lecture Notes in Computer Science, vol 11464. Springer, Cham.

Non Patent Literature 2: Alberto Torres, W. A. et al. (2018). Post-Quantum One-Time Linkable Ring Signature and Application to Ring Confidential Transactions in Blockchain (Lattice RingCT v1.0). In: Susilo, W., Yang, G. Information Security and Privacy. ACISP 2018. Lecture Notes in Computer Science, vol 10946. Springer, Cham.

### SUMMARY OF INVENTION

### Technical Problem

However, a linkable ring signature of the related art based on the quantum computer resistant cryptography has a problem that its implementation is complex.

The present disclosure has been made in view of the above circumstances, and an object of the present disclosure is to easily implement a linkable ring signature based on a quantum computer resistant cryptography.

### Solution to Problem

According to an aspect of the present disclosure, a ring signature system includes: a plurality of member terminals belonging to a ring signature group; and a verifier terminal that verifies a ring signature. Each member terminal among the member terminals includes a key generation unit configured to generate a public key and a secret key of lattice-based cryptography as a verification key and a signature key, respectively, and a signature generation unit configured to generate a signature for a message by a linkable ring signature to which a Schnorr signature is applied using the signature key of the member terminal and verification keys of the other member terminals. The verifier terminal includes a verification unit configured to verify the signature using a verification key of the member terminal and the message.

### Advantageous Effects of Invention

A linkable ring signature based on a quantum computer resistant cryptography can be easily implemented.

### BRIEF DESCRIPTION OF DRAWINGS

FIG. 1 is a diagram illustrating an overall configuration example of a ring signature system according to an embodiment.

FIG. 2 is a diagram illustrating a functional configuration example of a ring member terminal according to the embodiment.

FIG. 3 is a diagram illustrating a functional configuration example of a verifier terminal according to the embodiment.

FIG. 4 is a flowchart illustrating an example of a key generation process according to the embodiment.

FIG. 5 is a sequence diagram illustrating an example of group signature generation and verification processes according to the embodiment.

FIG. 6 is a flowchart illustrating an example of a double signature detection process according to the embodiment.

FIG. 7 is a diagram illustrating a hardware configuration example of a computer.

### DESCRIPTION OF EMBODIMENTS

Hereinafter, an embodiment of the present invention will be described. In the following embodiment, a ring signature system 1 that performs signature and verification using a linkable ring signature obtained by applying Fiat-Shamir transformation (Schnorr signature) to a lattice cryptography-based linkable ring signature (LRS) will be described. The ring signature system 1 can implement a linkable ring signature based on quantum computer resistant cryptography that can be implemented more simply than in the related art.

### Preparation

Hereinafter, some symbols, terms, and the like are prepared.

Anonymity means that a signer is not identified from a signature. This can also mean that there is randomness in the number of ring members when the verification key used to verify the signature is identified.

Linkability means that, when there is a double signature, signatures can be combined (or matched).

Traceability means that a signer can be identified (or tracked) when there is a double signature. Meanwhile, untraceability means that a signer cannot be identified (or tracked). If there is untraceability, there is also anonymity.

It is assumed that N is the number of members of the group (hereinafter also referred to as a ring signature group) that performs a ring signature. In addition, a member belonging to a ring signature group is also referred to as a ring member.

π represents a ring member (signer) that performs a signature. That is, π∈[N]={1, . . . , N}. It is assumed that N+1=1 and 0=N in the index representing the ring member (that is, it is assumed that 1 follows immediately after N, and N immediately precedes 1).

It is assumed that q be a prime number. It is assumed that m, n, and k are preset parameters, each of which takes an integer value of 1 or more.

It is assumed that H₁ and H₂ are hash functions defined below.

$${H}_{1} : {\{ 0 , 1 \}}^{*} \to {\{ - d , … , 0 , … , d \}}^{m \times k}$$

$${H}_{2} : {\{ 0 , 1 \}}^{*} \to {Z}_{q}^{k}$$

Here, Z_{q} represents a set of integers equal to or greater than 0 and less than q, and {0, 1}* represents a bit string of any length. Here, d is a preset parameter and takes an integer value of 1 or more.

A discrete normal distribution with a standard deviation σ and an average of 0 is defined as Dₒ_{^{m}}. It is assumed that A is information generated uniformly and randomly from Z_{q}_{^{n×m}}. A is public information common to the entire system. σ is a preset parameter.

### Overall Configuration Example of Ring Signature System 1

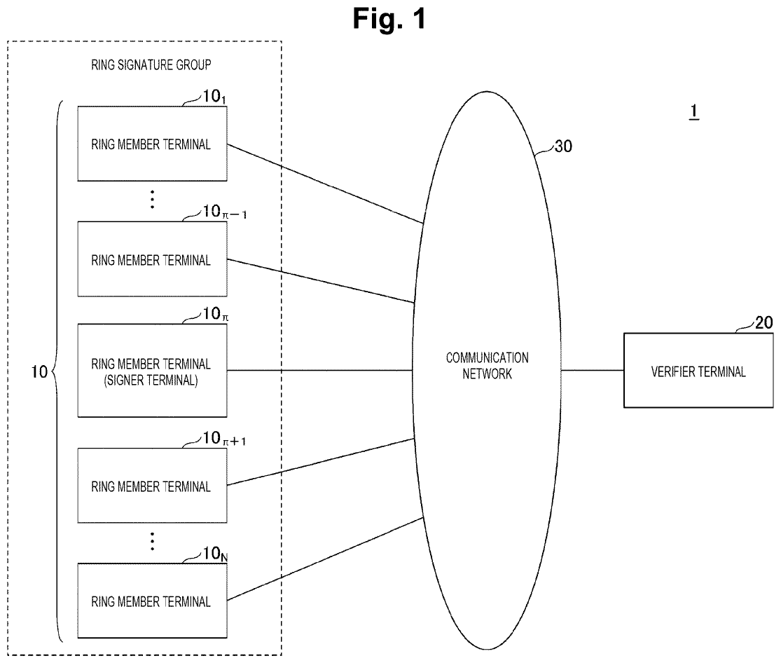

An overall configuration example of the ring signature system 1 according to the embodiment is illustrated in FIG. 1. As illustrated in FIG. 1, the ring signature system 1 according to the embodiment includes a plurality of ring member terminals 10 and one or more verifier terminals 20. These terminals are communicably connected via a communication network 30 including, for example, the Internet. Hereinafter, when the ring member terminals 10 are distinguished from each other, the ring member terminal is referred to as a ring member terminal 10ᵢ (where i∈[N]). The ring member terminal 10_{π} is the ring member terminal 10 of the signer and is also referred to as a signer terminal 10_{π}.

The ring member terminal 10 is any of various terminals that are ring members belonging to a ring signature group. Examples of the ring member terminal 10 include a personal computer (PC), a smartphone, a tablet terminal, a general-purpose server, and any of various Internet of Things (IoT) devices.

The verifier terminal 20 is any of various terminals serving as a verifier of the ring signature. Examples of the verifier terminal 20 include a PC, a smartphone, a tablet terminal, and any of various IoT devices.

The entire configuration example of the ring signature system 1 illustrated in FIG. 1 is exemplary, and the present invention is not limited thereto.

### Functional Configuration Example of Ring Member Terminal 10 and Verifier Terminal 20

Hereinafter, functional configuration examples of the ring member terminal 10 and the verifier terminal 20 will be described.

### Ring Member Terminal 10

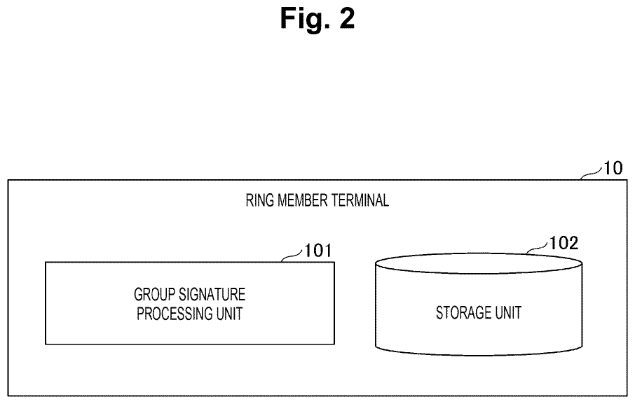

A functional configuration example of the ring member terminal 10 according to the embodiment is illustrated in FIG. 2. As illustrated in FIG. 2, the ring member terminal 10 according to the embodiment includes a group signature processing unit 101 and a storage unit 102. The group signature processing unit 101 is implemented through, for example, a process in which one or more programs installed in the ring member terminal 10 are executed by an arithmetic device such as a central processing unit (CPU). The storage unit 102 is implemented by, for example, a storage device such as a hard disk drive (HDD), a solid state drive (SSD), or a flash memory.

The group signature processing unit 101 executes a process of generating a group signature for the given message. The storage unit 102 stores various types of information (for example, a secret key (signature key), a public key (verification key), public information A, hash functions H₁ and H₂, a message to which a signature is added, and the like).

### Verifier Terminal 20

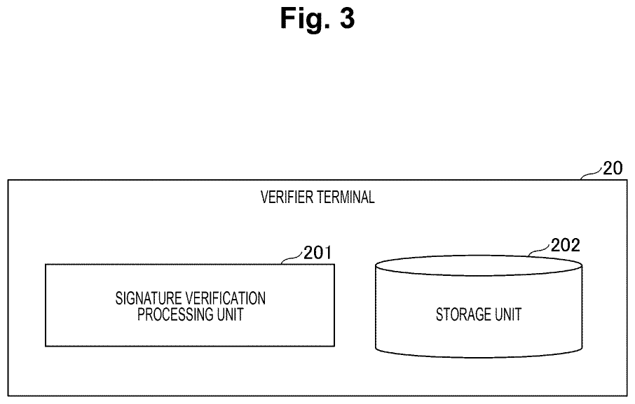

A functional configuration example of the verifier terminal 20 according to the embodiment is illustrated in FIG. 3. As illustrated in FIG. 3, the verifier terminal 20 according to the embodiment includes a signature verification processing unit 201 and a storage unit 202. The signature verification processing unit 201 is implemented, for example, through a process in which one or more programs installed in the verifier terminal 20 are executed by an arithmetic device such as a CPU. The storage unit 202 is implemented with, for example, a storage device such as an HDD, an SSD, or a flash memory.

The signature verification processing unit 201 executes a process of verifying a signature attached to a message. The signature verification processing unit 201 executes a process of detecting a double signature of the signature added to the message. The storage unit 202 stores various types of information (for example, a secret key (signature key), a public key (verification key), public information A, the hash function H₁, and the like).

### Key Generation Process

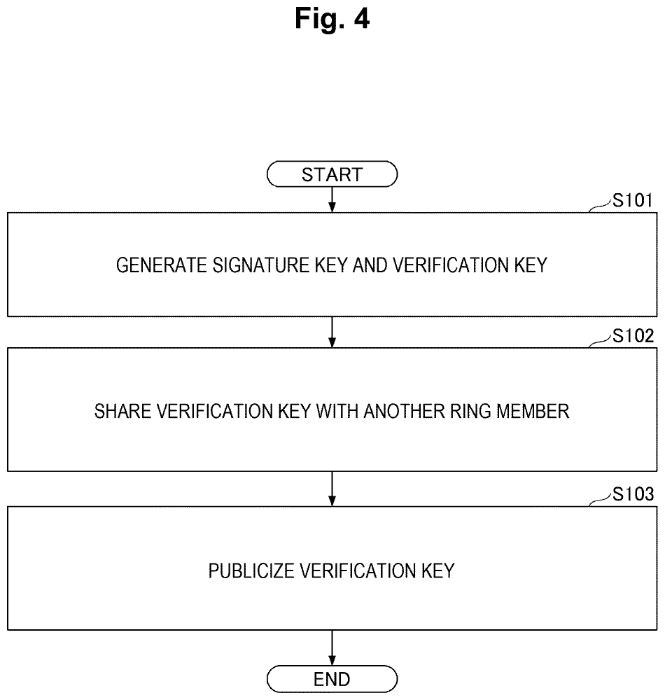

A key generation process according to the embodiment will be described below with reference to FIG. 4. The key generation process illustrated in FIG. 4 is executed by each ring member terminal 10. Hereinafter, a case where a certain ring member terminal 10ᵢ executes the key generation process will be described.

The group signature processing unit 101 of the ring member terminal 10ᵢ generates a signature key skᵢ and a verification key pkᵢ by the following procedures 1-1 to 1-3 (step S101).

In procedure 1-1, the group signature processing unit 101 of the ring member terminal 10ᵢ generates Xᵢ uniformly and randomly from {−d, . . . , 0, . . . , d}^{m×k}.

In procedure 1-2, the group signature processing unit 101 of the ring member terminal 10ᵢ subsequently sets Yᵢ←AXᵢ.

In procedure 1-3, the group signature processing unit 101 of the ring member terminal 10ᵢ then sets pkᵢ←Yᵢ and skᵢ←Xᵢ.

Next, the group signature processing unit 101 of the ring member terminal 10ᵢ shares the verification key (public key) pkᵢ of the member terminal with another ring member terminal 10ⱼ (where j≠i and j∈[N]) (step S102).

The group signature processing unit 101 of the ring member terminal 10ᵢ publicizes the verification key (public key) pkᵢ of the terminal member (step S103).

### Group Signature Generation and Verification Processes

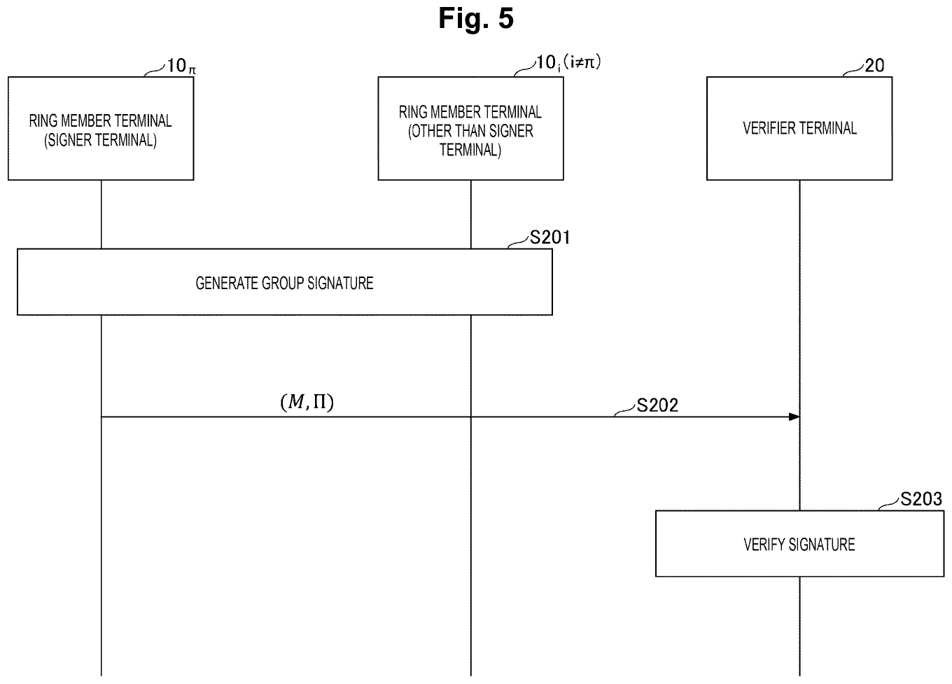

Hereinafter, group signature generation and verification processes according to the embodiment will be described with reference to FIG. 5.

The group signature processing unit 101 of the ring member terminal 10 generates a group signature by the following procedures 2-1 to 2-9 (step S201).

In procedure 2-1, the group signature processing unit 101 of the ring member terminal 10_{π} generates a ring member public key list L by L←{pk₁, . . . , pk_{N}}. The ring member public key list L is publicized to the other ring member terminals 10 and the verifier terminal 20.

The group signature processing unit 101 of the ring member terminal 10_{π} may generate the ring member public key list L by, for example, L←{pk₁, . . . , pk_{N}′} (N′<N). At this time, the signer may select or designate which ring member's public key is included in the ring member public key list L. When the ring member public key list L is generated by L←{pk₁, . . . , pk_{N}′}, N may be replaced with N′ in each of the following procedures.

In procedure 2-2, the group signature processing unit 101 of the ring member terminal 10_{π} subsequently generates a tag information T by H←H₂(L) and T←HX_{π}. The tag information T is publicized to the other ring member terminal 10 and the verifier terminal 20.

In procedure 2-3, the group signature processing unit 101 of the ring member terminal 10_{π} subsequently generates u randomly from the discrete normal distribution Dₒ_{^{m}}. It is noted that u is represented by m discrete values (integer values).

In procedure 2-4, the group signature processing unit 101 of the ring member terminal 10_{π} subsequently calculates c_{π+1}←H₁ (L, T, M, Au, Hu). Here, M is a message.

In procedure 2-5, for i=π+1, . . . , N, 1, . . . , π−1, the group signature processing unit 101 of the ring member terminal 10ᵢ generates the tag information Tᵢ by H←H₂ (L) and Tᵢ←HXᵢ. The tag information Tᵢ is publicized to the other ring member terminal 10 and the verifier terminal 20.

In procedure 2-6, the group signature processing unit 101 of the ring member terminal 10_{π} subsequently generates sᵢ (where i=π+1, . . . , N, 1, . . . , π−1) randomly from the discrete normal distribution Dₒ_{^{m}}.

In procedure 2-7, the group signature processing unit 101 of the ring member terminal 10_{π} subsequently calculates cᵢ₊₁←H₁ (L, T, M, Asᵢ+Yᵢcᵢ, Hsᵢ+Tᵢcᵢ) for i=π+1, . . . , N, 1, . . . , π−1.

In procedure 2-8, the group signature processing unit 101 of the ring member terminal 10_{π} sets s_{π}←u−X_{π}c_{π}.

In procedure 2-9, the group signature processing unit 101 of the ring member terminal 10_{π} then generates the signature π by π←(c₁, s₁, . . . , s_{N}, T).

Subsequently, the group signature processing unit 101 of the ring member terminal 10_{π} transmits a signature message (M, π) to the verifier terminal 20 (step S202). At this time, a transmission source of the message with the signature (M, π) is information indicating a ring signature group.

When the signature message (M, π) is received, the signature verification processing unit 201 of the verifier terminal 20 verifies the signature π in the following procedures 3-1 to 3-3 (step S203).

In procedure 3-1, the signature verification processing unit 201 of the verifier terminal 20 determines whether there is i for which |sᵢ|≥β is satisfied for a preset parameter β. In other words, the signature verification processing unit 201 determines whether there is i for which sᵢ is not small. When there is i for which |sᵢ|≥β is satisfied, the signature verification processing unit 201 determines that verification has failed.

In procedure 3-2, the signature verification processing unit 201 of the verifier terminal 20 subsequently calculates cᵢ₊₁←H₁ (L, T, M, Asᵢ+Yᵢcᵢ, Hsᵢ+Tᵢcᵢ) for i=1, . . . , and N−1.

In procedure 3-3, the signature verification processing unit 201 of the verifier terminal 20 then determines whether c₁=H₁ (L, T, M, As_{N}+Y_{N}c_{N}, Hs_{N}+T_{N}c_{N}) is satisfied. The signature verification processing unit 201 determines that the verification is successful when it is determined that c₁=H₁ (L, T, M, As_{N}+Y_{N}c_{N}, Hs_{N}+T_{N}c_{N}) is satisfied, and determines that the verification is unsuccessful otherwise.

### Double Signature Detection Process

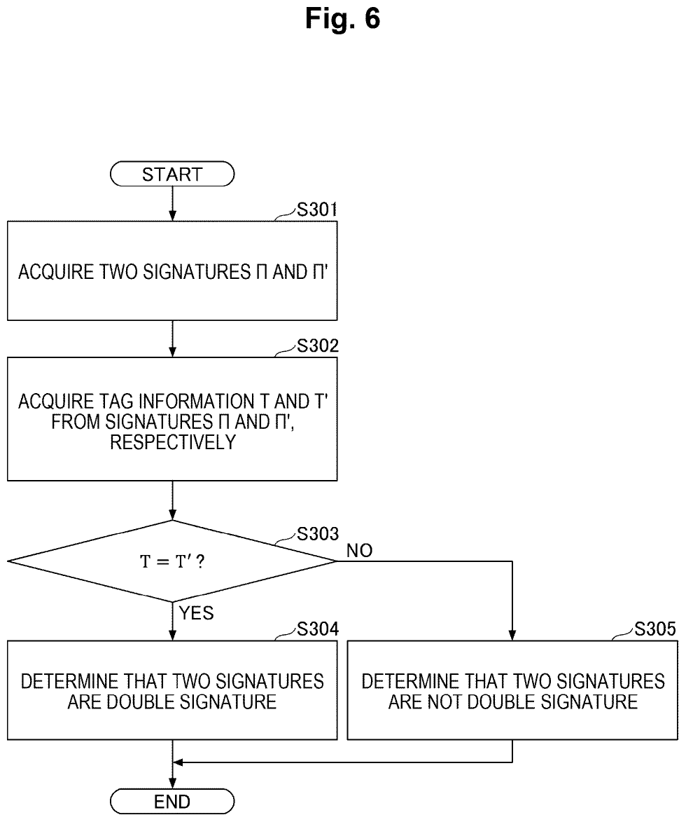

Hereinafter, the double signature detection processing according to the embodiment will be described with reference to FIG. 6. Hereinafter, a case where it is determined whether two signatures π=(c₁, s₁, . . . , s_{N}, T) and π′=(c₁′, s₁′, . . . , s_{N}′, T′) is a double signature will be described.

The signature verification processing unit 201 of the verifier terminal 20 acquires two signatures π and π′ (step S301).

Subsequently, the signature verification processing unit 201 of the verifier terminal 20 acquires the tag information T and T′ from the two signatures π and π′, respectively (step S302).

Subsequently, the signature verification processing unit 201 of the verifier terminal 20 determines whether T=T′ is satisfied (step S303).

When it is determined in step S303 described above that T=T′ is satisfied, the signature verification processing unit 201 of the verifier terminal 20 determines that the two signatures π and π′ are a double signature (that is, the signatures are made by the same signer) (step S304).

Conversely, when it is not determined in the foregoing step S303 that T=T′ is satisfied, the signature verification processing unit 201 of the verifier terminal 20 determines that the two signatures π and π′ are not a double signature (step S305).

### Hardware Configuration Example of Ring Member Terminal 10 and Verifier Terminal 20

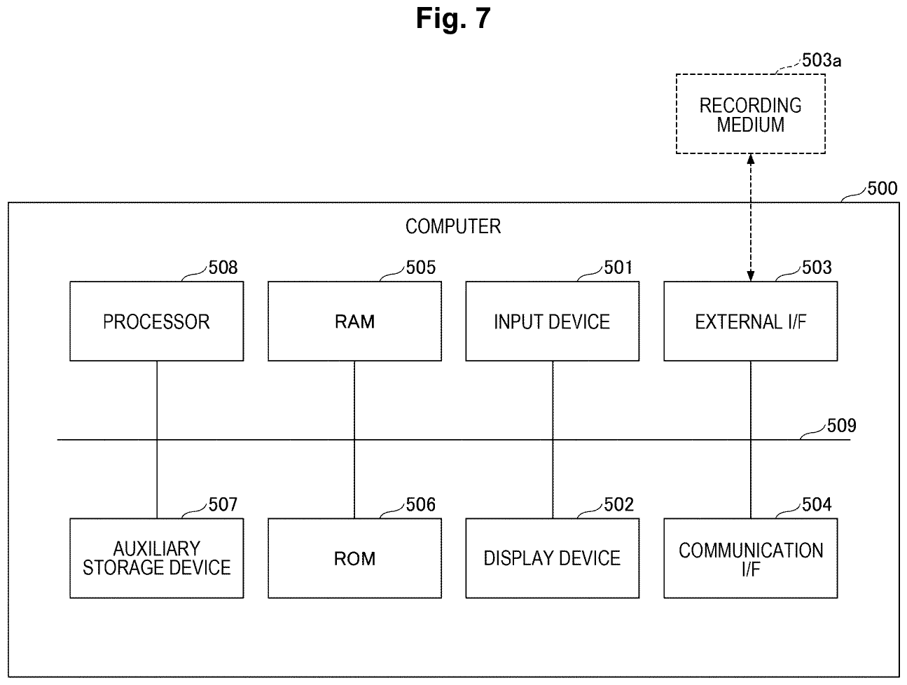

The ring member terminal 10 and the verifier terminal 20 according to the embodiment are implemented by, for example, a hardware configuration of a computer 500 illustrated in FIG. 7. The computer 500 illustrated in FIG. 7 includes an input device 501, a display device 502, an external I/F 503, a communication I/F 504, a random access memory (RAM) 505, a read only memory (ROM) 506, an auxiliary storage device 507, and a processor 508. These types of hardware are communicably connected via a bus 509.

The input device 501 is, for example, a keyboard, a mouse, a touch panel, a physical button, or the like. The display device 502 is, for example, a display, a display panel, or the like. The computer 500 need not include, for example, at least one of the input device 501 or the display device 502.

The external I/F 503 is an interface with an external device such as a recording medium 503a. The computer 500 can read or write the recording medium 503a via the external I/F 503. Examples of the recording medium 503a include a flexible disk, a compact disc (CD), a digital versatile disk (DVD), a secure digital memory card (SD memory card), and a Universal Serial Bus (USB) memory card.

The communication I/F 504 is an interface for connecting the computer 500 to a communication network. The RAM 505 is a volatile semiconductor memory (storage device) that temporarily retains programs and data. The ROM 506 is a nonvolatile semiconductor memory (storage device) capable of retaining programs and data even when power is turned off. The auxiliary storage device 507 is, for example, a storage device such as an HDD, an SSD, or a flash memory. The processor 508 is, for example, an arithmetic device such as a CPU.

The ring member terminal 10 and the verifier terminal 20 according to the embodiment have, for example, a hardware configuration of the computer 500 illustrated in FIG. 7, so that the above-described various processes can be implemented. The hardware configuration of the computer 500 illustrated in FIG. 7 is exemplary, and the hardware configuration of the computer 500 is not limited thereto. For example, the computer 500 may include a plurality of auxiliary storage devices 507 and a plurality of processors 508, may exclude a part of the illustrated hardware, or may include various types of hardware other than the illustrated hardware.

### Conclusion

As described above, in the ring signature system 1 according to the embodiment, the ring signature mechanism is simply configured by applying the Fiat-Shamir transform (Schnorr signature) to the linkable ring signature (LRS) based on lattice-based cryptography. Therefore, it is possible to implement the system more simply than the conventional couplable ring signature based on the quantum computer resistant cryptography, and for example, it is possible to reduce the implementation cost or implement the system on a terminal having insufficient hardware resources. In addition to this, in the ring signature system 1 according to the embodiment, since a trapdoor is not necessary and the linkable ring signature based on quantum computer resistant cryptography is configured, the sizes of a key length and a signature length can also be reduced, and an efficient ring signature can also be implemented.

The ring signature system 1 according to the embodiment can detect a double signature. Therefore, for example, when the present disclosure is applied to a blockchain or the like, it is also possible to detect fraudulence such as double use of currency while protecting the privacy/anonymity of a signer.

The linkable ring signature configured in the embodiment has anonymity, linkability, and untraceability, as in a linkable ring signature of the related art based on quantum computer resistant cryptography.

The present invention is not limited to the above embodiment specifically disclosed, and various modifications and changes, combinations with known technique, and the like can be made without departing from the scope of the claims.

### REFERENCE SIGNS LIST

1 Ring signature system
10 Ring member terminal
20 Verifier terminal
30 Communication network
101 Group signature processing unit
102 Storage unit
201 Signature verification processing unit
202 Storage unit
500 Computer
501 Input device
502 Display device
503 External I/F
503a Recording medium
504 Communication I/F
505 RAM
506 ROM
507 Auxiliary storage device
508 Processor
509 Bus

1. A ring signature system comprising:
a plurality of member terminals belonging to a ring signature group; and
a verifier terminal that verifies a ring signature,
wherein each member terminal among the member terminals includes
a memory; and
a processor coupled to the memory and configured to:
generate a public key and a secret key of lattice-based cryptography as a verification key and a signature key, respectively, and
generate a signature for a message by a linkable ring signature to which a Schnorr signature is applied using the signature key of the member terminal and verification keys of the other member terminals, and
the verifier terminal includes
a memory; and
a processor coupled to the memory and configured to:
verify the signature using a verification key of the member terminal and the message.

2. The ring signature system according to claim 1, wherein the processor of each member terminal is configured to generate tag information of the member terminal using a hash value of a verification key list of the other member terminals and the signature key of the member terminal and generate a signature including the tag information.

3. The ring signature system according to claim 2, wherein
when an index representing each of the other member terminals is i=1, . . . , π−1, π+1, . . . , and N, and an index representing the member terminal is i=π,
the processor of each member terminal is configured to
calculate c_{π+1}←H₁ (L, T, M, Au, Hu), where L is the verification key list, T is the tag information of the member terminal, M is the message, A is public information given in advance, u is a random number, and His a hash value of the verification key list L, and cᵢ₊₁←H₁ (L, T, M, Asᵢ+Yᵢcᵢ, Hsᵢ+Tᵢcᵢ), where i=1, . . . , π−1, π+1, . . . , and N, sᵢ is a random number, Yᵢ is a verification key of the member terminal corresponding to the index i, and Tᵢ is tag information of the member terminal corresponding to the index i,
calculate s_{π} by using c_{π}, and
generate (c₁, s₁, . . . , s_{N}, T) as the signature.

4. The ring signature system according to claim 3, wherein the processor of each member terminal is configured to calculate s_{π} by s_{π}←u−X_{π}c_{π}, where X_{π} is the signature key of the member terminal.

5. The ring signature system according to claim 3, wherein the processor of the verifier terminal is configured to
calculate cᵢ₊₁←H₁ (L, T, M, Asᵢ+Yᵢcᵢ, Hsᵢ+Tᵢcᵢ) for i=1, . . . , N−1, and
successfully verify the signature when c₁=H₁ (L, T, M, As_{N}+Y_{N}c_{N}, Hs_{N}+T_{N}c_{N}).

6. A member terminal in a ring signature system including a plurality of member terminals belonging to a ring signature group and a verifier terminal verifying a ring signature, the member terminal comprising:
a memory; and
a processor coupled to the memory and configured to:
generate a public key and a secret key of lattice-based cryptography as a verification key and a signature key, respectively; and
generate a signature for a message by a linkable ring signature to which a Schnorr signature is applied using the signature key of the member terminal and verification keys of the other member terminals.

7. A method used for a ring signature system including a plurality of member terminals belonging to a ring signature group and a verifier terminal verifying a ring signature, the method comprising:
generating, by each member terminal among the member terminals, a public key and a secret key of lattice-based cryptography as a verification key and a signature key, respectively;
generating, by the each member terminal, a signature for a message by a linkable ring signature to which a Schnorr signature is applied using the signature key of the member terminal and verification keys of the other member terminals; and
verifying, by the verifier terminal, the signature using a verification key of the member terminal and the message.

8. A non-transitory computer-readable recording medium storing a program causing a computer to perform the method of claim 7.
